(19) United States
(12) Patent Application Publication
(10) Pub. No.: US 2015/0207854 A1
(43) Pub. Date: Jul. 23, 2015

(54) EXTERNAL APPLICATION REQUEST

(71) Applicant: Google Inc., Mountain View, CA (US)

(72) Inventor: Michele Aiello, London (GB)

(73) Assignee: Google Inc., Mountain View, CA (US)

(21) Appl. No.: 13/663,383

(22) Filed: Oct. 29, 2012

(51) Int. Cl. H04L 29/08; G06F 17/30; H04L 29/06

(52) U.S. Cl. CPC H04L 67/10; H04L 67/42; G06F 17/30864

(57) ABSTRACT

Methods for switching between a web browser and an application on a mobile device are provided. In one aspect, a method includes receiving a request from a calling application from among a plurality of applications on a mobile device to load a web page externally in a mobile web browser, and loading the web page externally in the mobile web browser. The method also includes receiving a request in the mobile web browser to end viewing of content within the web browser, identifying the calling application to load from among the plurality of applications, and loading the calling application in response to the request to end viewing of content within the mobile web browser. Systems and machine-readable media are also provided.

### BACKGROUND

1. Field

The present disclosure generally relates to the transmission of data over a network, and more particularly to the use of a mobile computing device to display data communicated over a network.

2. Description of the Related Art

Applications for mobile devices often display content that links to content on the Internet, and particularly to the World Wide Web. In certain applications (“calling applications”), activation of a link to Internet content in an application causes a limited web browser interface for viewing a web page corresponding to the link to appear within the calling application. The limited web browser interface is often restricted to simply viewing the web page, and does not permit, for example, the ability to browse forward and backward from the web page, conduct searches, return to the application, bookmark a web page address, and various other standard features available in a web browser. Additionally, because the limited web browser interface appears within the calling application, the user may be restricted to viewing just the web page corresponding to the link, and not any other web pages.

### SUMMARY

According to one embodiment of the present disclosure, a computer-implemented method for switching between a web browser and an application on a mobile device is provided. The method includes receiving a request from a calling application from among a plurality of applications on a mobile device to load a web page externally in a mobile web browser, and loading the web page externally in the mobile web browser. The method also includes receiving a request in the mobile web browser to end viewing of content within the web browser, identifying the calling application to load from among the plurality of applications, and loading the calling application in response to the request to end viewing of content within the mobile web browser.

According to another embodiment of the present disclosure, a system for switching between a web browser and an application on a mobile device is provided. The system includes a memory that includes a plurality of applications, and a processor. The processor is configured to receive a request from a calling application from among a plurality of applications on a mobile device to load a web page externally in a mobile web browser, and load the web page externally in the mobile web browser. The processor is also configured to receive a request in the mobile web browser to end viewing of content within the web browser, identify the calling application to load from among the plurality of applications, and load the calling application in response to the request to end viewing of content within the mobile web browser. Loading the web page externally in the mobile web browser includes switching from the calling application to the mobile web browser, and wherein loading the calling application includes switching from the mobile web browser to the calling application.

According to a further embodiment of the present disclosure, a machine-readable storage medium includes machine-readable instructions for causing a processor to execute a method for switching between a web browser and an application on a mobile device is provided. The method includes receiving a request to load a web page externally in a mobile web browser from a calling application from among a plurality of applications on a mobile device running an operating system, the request includes a Uniform Resource Identifier (URI) scheme configured for instructing the operating system to load the mobile web browser. The method also includes loading the web page externally in the mobile web browser and receiving a request in the mobile web browser to end viewing of content within the web browser. The method further includes identifying the calling application to load from among the plurality of applications, and loading the calling application in response to the request to end viewing of content within the mobile web browser. The URI scheme includes at least one of an identification of the calling application, an action to be performed by the mobile web browser, a parameter indicating the action to be performed by the mobile web browser, a parameter specifying how to load the calling application in response to the request to end viewing of content within the web browser, a parameter indicating how to display the web page in the mobile web browser, a parameter requesting the mobile web browser to automatically add the web page as a bookmark, a parameter indicating a search query to submit to a search engine, a parameter indicating a non-mobile version of the web page is to be loaded in the mobile web browser, or a parameter indicating a request to load the web page in a private web page browsing window.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for switching between a web browser and an application on a mobile device.

FIG. 2 is a block diagram illustrating an example mobile client and server from the architecture of FIG. 1 according to certain aspects of the disclosure.

FIG. 3 illustrates an example process for switching between a web browser and an application on a mobile device using the example mobile client of FIG. 2.

FIGS. 4A-4D are example illustrations associated with the example process of FIG. 3.

FIG. 5 is a block diagram illustrating an example computer system with which the clients and server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed system provides functionality for a calling application on a mobile device to call an external fully featured web browser in response to a request to view web page content in the calling application. Specifically, in response to a user request to view a web page in a calling application, the calling application uses a specific protocol configured on an operating system of the mobile device to load the web browser to display the web page. The protocol can include information regarding, for example, an identification of the calling application, an action to be performed by the loaded web browser, parameters for the action, information on how to return to the calling application, and how to display the web page.

For example, the protocol can include parameters that indicate the calling application is named “Social,” that Social is requesting a web browser to be externally loaded to display a web page, that the web page to be displayed is available at “wwx.yoursocial.com,” that the calling application should be identified as “Social App” in the web browser, and that the web page should be displayed in a new web browser “tab” window. When the web browser is externally loaded, the web browser can provide each of the standard features available to the web browser, including, for example, the ability to browse forward and backward from the “wwx.yoursocial.com” web page, conduct searches, return to the application, bookmark a web page address, and various other standard features available in the web browser. The web browser can also display an icon or label that permits a user to easily return to the calling application. The icon or label when activated can cause the calling application to be displayed.

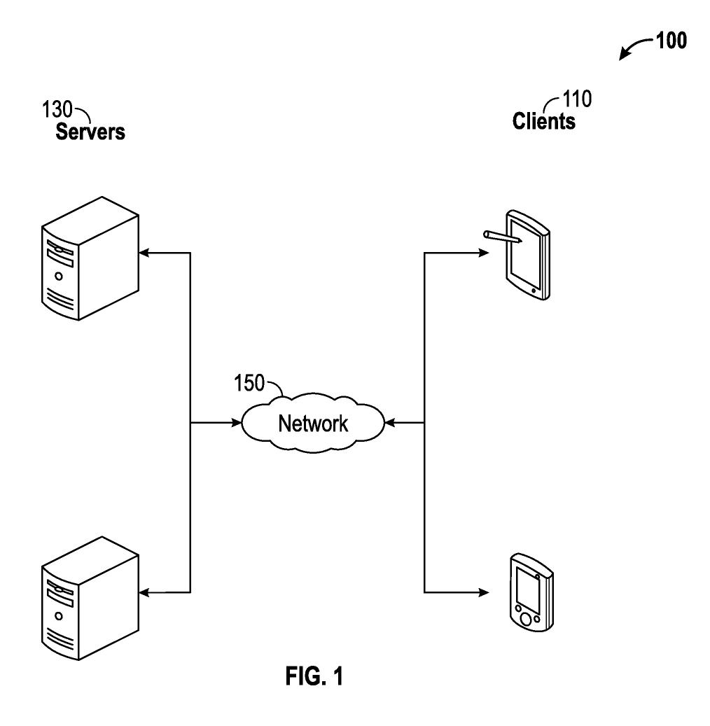

FIG. 1 illustrates an example architecture 100 for switching between a web browser and an application on a mobile device. The architecture 100 includes servers 130 and mobile clients 110 connected over a network 150.

Each of the mobile clients 110 is configured to download, install, and run mobile applications on a mobile operating system. The mobile applications, which include a web browser, are configured to run on clients 110 that are mobile, but may also run on clients 110 that are non-mobile (not illustrated). The mobile clients 110 can be, for example, smartphones, tablet computers, or PDAs, or any other portable device having appropriate processor, memory, and communications capabilities.

A mobile application, once installed on a client 110, is configured to load content for display that links to a web page on any one or multiple servers 130 hosting the web page. The servers 130 can be any device having an appropriate processor, memory, and communications capability for hosting the data for hosting the web pages. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

The mobile application (or “calling application”) on the mobile client 110 is configured to load content for display that links to a web page on any one or multiple servers 130. The calling application is also configured to request (or “call”) a web browser on the mobile client 110 to load the web page externally to the mobile application. For example, a mobile operating system of the mobile device can cause the application being displayed to switch from the calling application to the web browser in response to the request, as opposed to having the web browser load within the display of the calling application. The format of the request is configured for execution by the mobile operating system and may include certain parameters indicating how the web browser should load the web page. When the web page is loaded externally in the web browser, a user of the web browser has access to each of the features native to the web browser because, for example, the web browser is running externally and independently from the calling application. The features can be, for example, the ability to browse the network 150 for content, search the network 150 for content, save an address for a web page, load other web pages, and so on. When the user has completed use of the web browser, the user may select an element of the graphical user interface of the web browser, such as a button or icon, to immediately return to the calling application. In certain aspects, the user is returned to the same state of the calling application as the state in which the calling application requested the web browser.

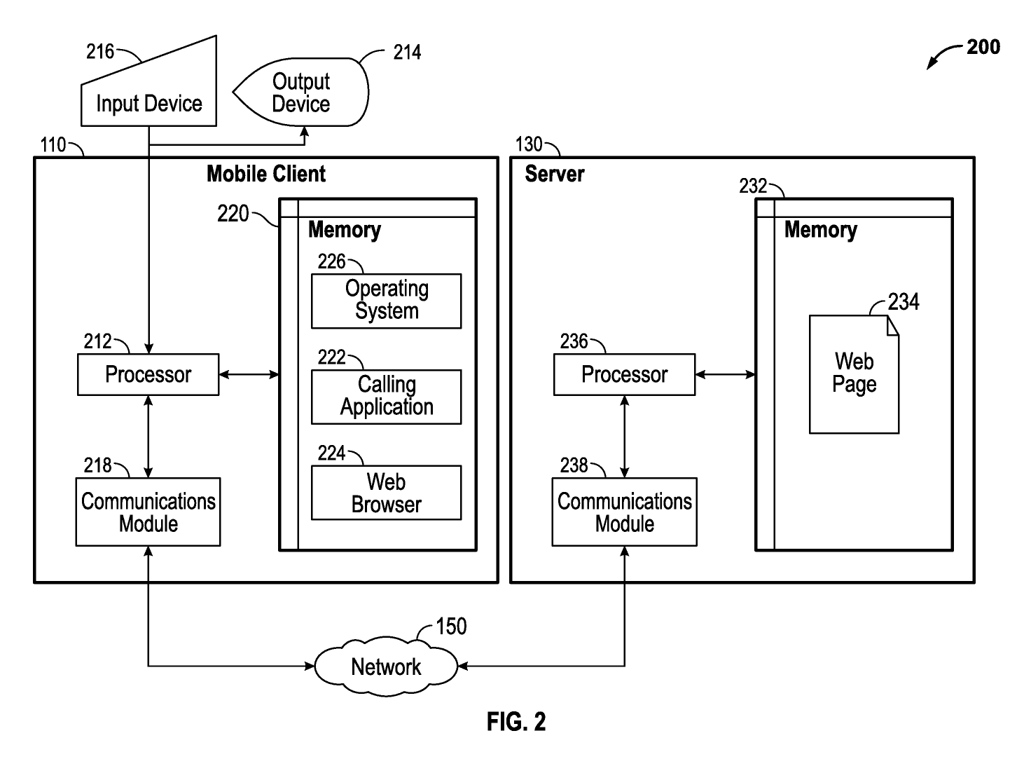

FIG. 2 is a block diagram illustrating an example server 130 and mobile client 110 in the architecture 100 of FIG. 1 according to certain aspects of the disclosure. The mobile client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The mobile client 110 includes a processor 212, a communications module 218, and a memory 220 that includes an operating system 226, calling application 222, and web browser 224. In certain aspects, the operating system 226 is particularly suited for running on a mobile device, such as the mobile client 110. The calling application 222, which may be one of many applications in the memory 220 of the mobile client 110, can be, for example, a document viewer, an image editor, social network content viewer, or other content viewer configured to display content that links to other content configured for display in a web browser.

The processor 212 of the mobile client 110 is configured to execute instructions, such as instructions physically coded into the processor 212, instructions received from software in memory 220 (e.g., the operating system 226), or a combination of both. For example, the processor 212 of the mobile client 110 executes instructions to receive a request from a calling application from among a plurality of applications on the mobile client 110 to load a web page 234 stored in memory 232 on a server 130 externally in the web browser 224. The web browser 224 is configured to obtain a copy of the web page 234 from a processor 236 the server 130 over the network 150 using the respective communications modules 218 and 238 of the client 110 and server 130, and load the web page 234 externally in the web browser 224. In certain aspects, in response to the request to load the web page 234 in the web browser 224, the calling application 222 may (e.g., based on instructions from the operating system 226) provide, for display, an interface for a user of the calling application 222 to confirm that the web page 234 is to be loaded in the web browser 224. If the user provides a confirmation to the interface that the web page 234 is to be loaded in the web browser 224, then the processor 212 is configured to externally load the web page 234 in the web browser 224.

As discussed herein a loading of the web browser 224 in a way that is external to the calling application 222 includes instructing the web browser 224 to be displayed in a native graphical user interface of the web browser 224, and not, for instance, within the graphical user interface of the calling application 222. For example, the calling application 222, upon sending a request to the operating system 226 to load the web page 234 in the web browser 224, may be removed from a display (e.g., on output device 214) of the mobile client 110 and instead be replaced with a display of the web browser 224. The transition from the calling application 222 to the web browser 224 (and any later transition back to the calling application 222 from the web browser 224) may graphically appear as a switch from the graphical user interface of the calling application 222 to the graphical user interface of the web browser 224. The loading of the web browser 224 in a way that is external to the calling application 222 is not intended to include displaying the web browser 224 within the graphical user interface of the calling application 222 (e.g., with features native to the web browser 224 not being made available within the graphical user interface of the calling application 222). The loading of an application includes initializing the application if the application is not currently running, and providing the running application for display if the application is currently running.

The request to load the web page 234 in the web browser 224 may be received while the calling application 222 is in a specific state. For example, in the specific state of the calling application 222, a user may have entered data into the calling application that is not yet saved. In certain aspects, the state of the calling application 222 is preserved when the request is received, such that when a user is returned to the calling application 222 from the web browser 224, unsaved data entered by the user is still available to the user.

In certain aspects, the request to load the web page 234 in the web browser 224 uses a protocol configured for instructing the operating system to load the web browser 224. The protocol can be, for example, a Uniform Resource Identifier (URI) scheme. The protocol may be configured to receive certain parameters (e.g., from the calling application) as part of the request. The parameters may indicate to the operating system 226 how to load the web browser 224 in response to the request. For example, the parameters can include an identification of the calling application 222, such as a memory address for the calling application 222 or a name of the calling application 222. The parameters can also include an action to be performed by the web browser 224, such as loading the web page 234 as the primary web page browsing window (or “tab”) of the web browser 224.

A parameter can also specify how to load the calling application 222 in response to a request to end viewing of content within the web browser 224. For example, the parameter may specify an identification of the calling application 222 from among many possible applications on the mobile client 110, how the calling application 222 is to be requested, and in what state to load the calling application 222.

The protocol may also specify a parameter for indicating how to display the web page in the mobile web browser, such as loading the web page 234 in a new tab of the web browser 224, and a parameter for requesting the mobile web browser to automatically add the web page as a bookmark. The protocol may further specify a parameter indicating a search query to submit to a search engine, such as a search query for a term based on the web page 234 to be loaded. The protocol for the request may yet further specify a parameter indicating a non-mobile version of the web page 234 is to be loaded in the web browser 224, or a parameter indicating a request to load the web page in a private web page browsing window that does not track a user's web browsing session information.

The web browser 224 in which the web page 234 is configured to be loaded externally to the calling application 222 is itself configured to perform various functions (“standard features”). The functions, which may be standard or otherwise native to the web browser 224, are available when the web page 234 is loaded in the web browser 224 in response to the request. The functions include, for example, an ability to browse forward and backward to other web pages from the loaded web page 234, to conduct a web search, to select an interface (e.g., icon or other button) to return back to the calling application 222, to bookmark or otherwise save a web page address, to share a web page (e.g., with another device or user), to find content in the web page (e.g., finding text within a web page), to request a non-mobile version of the web page 234 be displayed, or to load another web page in a new tab window in the web browser 224.

In certain aspects, if the web browser 224 is not installed or otherwise available on the mobile client 110, the processor 212 is configured to provide, for display, an interface for downloading the web browser 224 in response to the request to load the web page 234 in the web browser 224. For example, a graphical user interface for downloading applications for the mobile client 110 may be provided from which a user can download the web browser 224.

The processor 212 is yet further configured to receive a request in the web browser 224 to end viewing of content within the web browser 224. The request to end viewing of content within the web browser 224 may be received from a user of the mobile client 110 when the user has, for example, completed viewing of the web page 234 or other content within the web browser 224. The request to end viewing of content within the web browser 224 may be received by the user selecting (e.g., clicking or touching) an image (e.g., icon for the calling application 222) or text identifying the calling application 222. The selection of the image or text indicates the user's request to end viewing of content within the web browser 224 and return to the calling application 222.

The processor 212 of the mobile client 110 is configured to identify the calling application 222 to load from among many applications on the mobile client 110 in response to the request to end viewing of content within the web browser 224, and load the identified calling application 222. The identification may be facilitated, for example, by referencing, for example, the parameter identifying the calling application 222 received as part of the request to load the web page 234 in the web browser 224. The parameter specifying how to load the calling application 222 in response to a request to end viewing of content may also be referenced by the operating system 226 to load the calling application 222 in response to the user's request to end viewing of content within the web browser 224. In certain aspects, the user is returned to the same state of the calling application 222 as the state in which the calling application 222 requested the web browser.

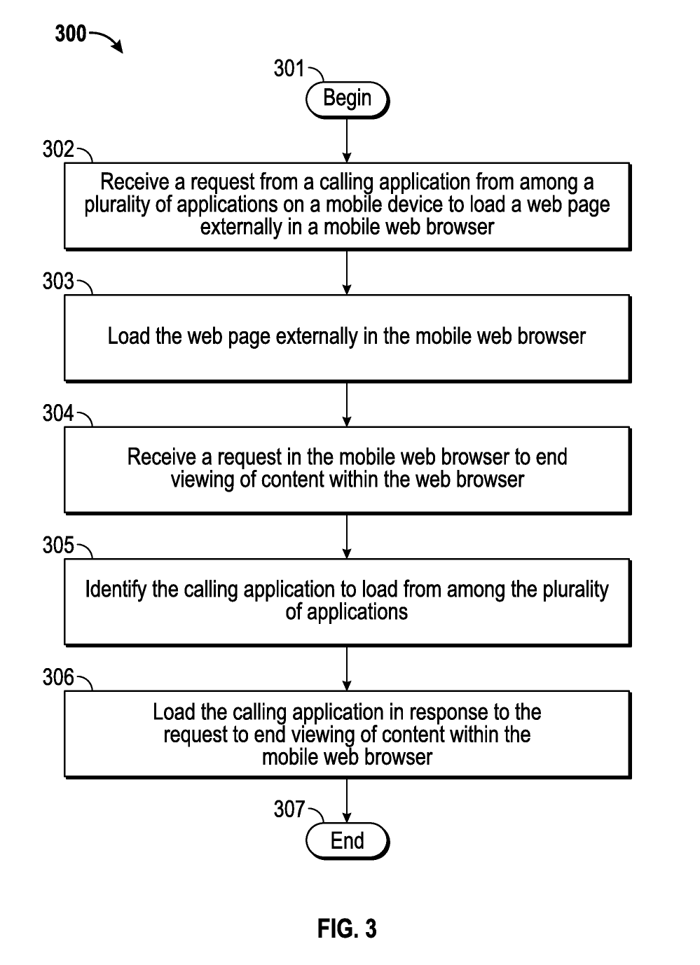

FIG. 3 illustrates an example process 300 for switching between a web browser and an application on a mobile device using the example mobile client 110 of FIG. 2. While FIG. 3 is described with reference to FIG. 2, it should be noted that the process steps of FIG. 3 may be performed by other systems. The process 300 begins by proceeding from beginning step 301 when a calling application 222, which is among a plurality of applications on the mobile client 110, receives an indication that a web page 234 is to be loaded for display, to step 302 when a request is received (e.g., by the operating system 226 or the web browser 224) from the calling application 222 to load the web page 234 externally in the web browser 224. Next, in step 303, the web page 234 is loaded externally in the web browser 224. Upon receipt of a request in the mobile web browser 224 in step 304 to end viewing of content within the web browser 224, the process 300 proceeds to step 305 in which the calling application 222 to load is identified from among the plurality of applications. Finally, in step 306, the calling application 222 is loaded in response to the request to end viewing of content within the web browser 224, and the process 300 ends in step 307.

FIG. 3 set forth an example process 300 for switching between a web browser and an application on a mobile device using the example mobile client 110 of FIG. 2. An example will now be described using the example process 300 of FIG. 3, a mobile client 110 that is a touchscreen smartphone, a calling application 222 that is a news aggregator application, and a web page 234 that is a news web page.

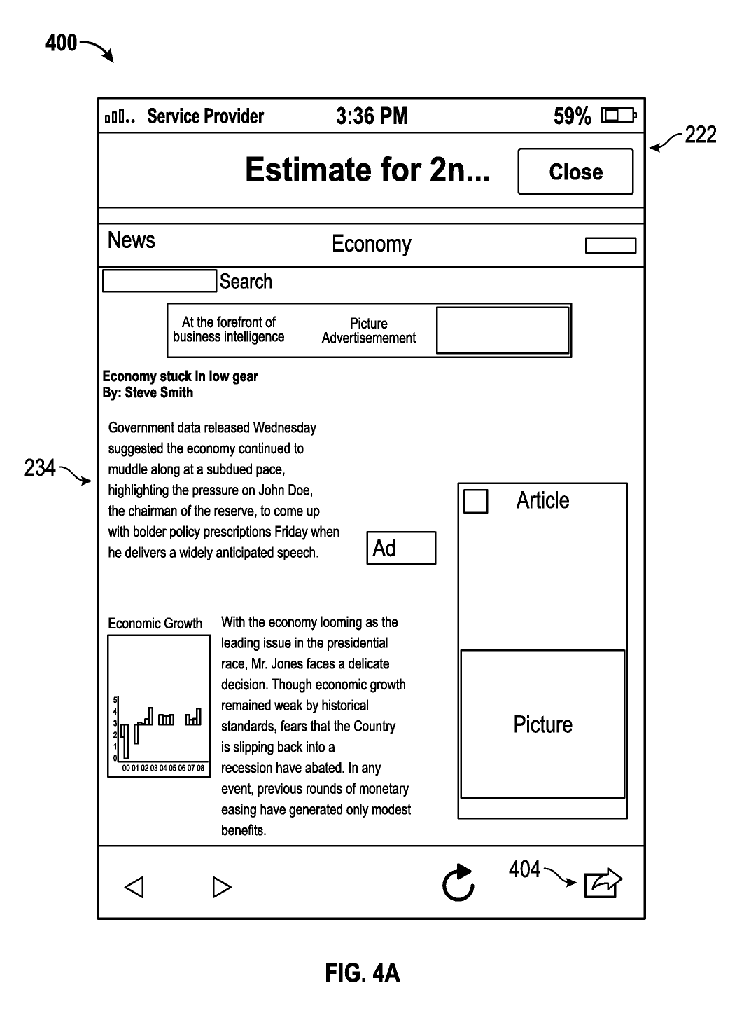

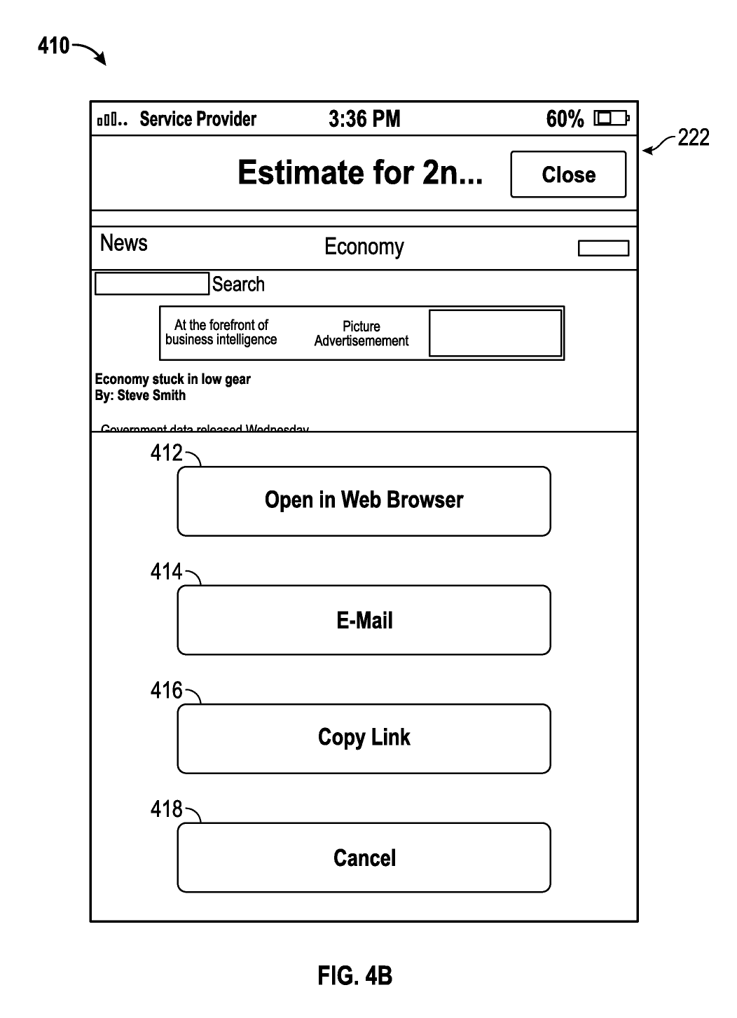

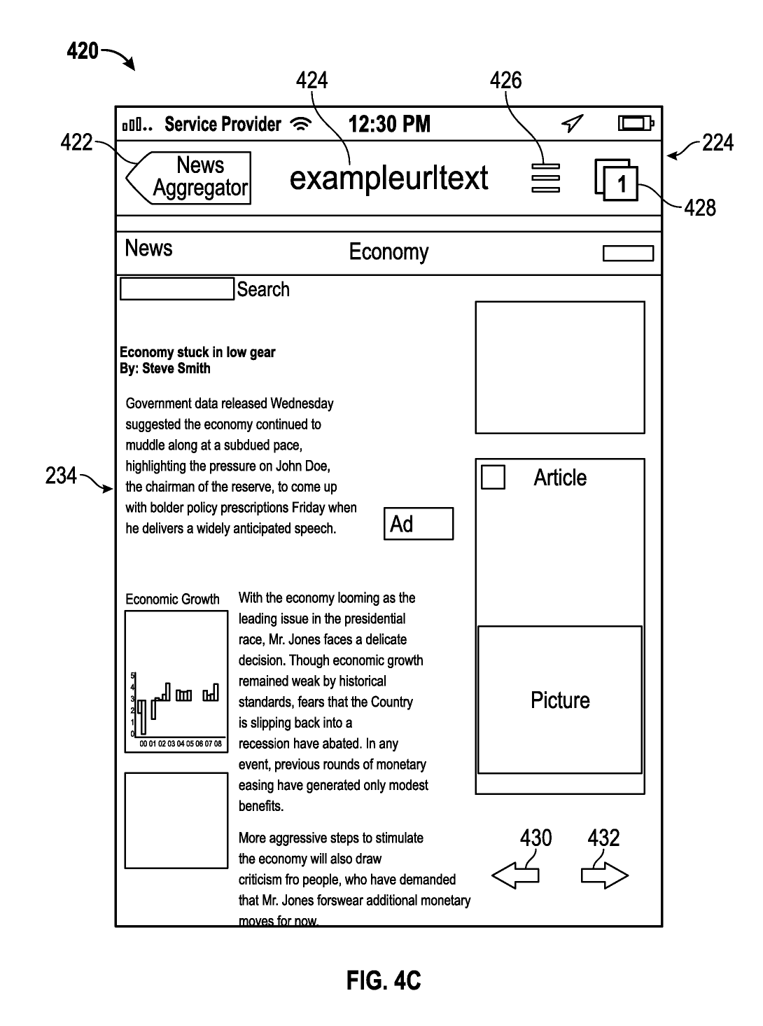

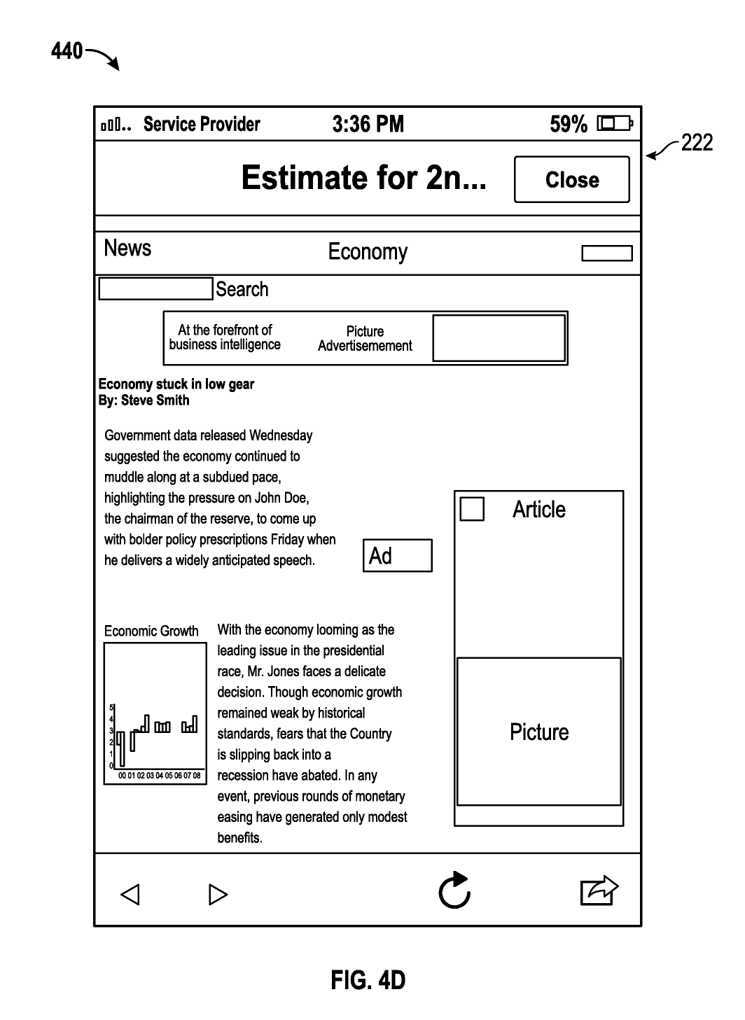

The process 300 begins by proceeding from beginning step 301 when the news aggregator application 222 receives a request from the user to display a web page in a web browser 224. FIG. 4A illustrates an example screenshot 400 of the news aggregator application 222. The news aggregator application 222 is providing the web page 234 for display. A user of the news aggregator application 222 provides a request to display the web page 234 in the web browser 224 by pressing a send button 404 displayed in the news aggregator application 222. Pressing the send button 404 provides the user with a selection of where the user would like to send or view the web page 234, as illustrated in the example screenshot 410 of FIG. 4B. The user may open 412 the web page 234 in the web browser 224, e-mail 414 a copy of the web page 234, copy 416 the address of the web page 234, or cancel 418 sending of the web page 234. The user selects to open 412 the web page 234 in the web browser 224 and a request to load the web page 234 externally in the web browser 224 is sent to the operating system 226 of the smartphone 110. The request includes parameters that identify the news aggregator application 222 as the calling application, request the web browser 224 to load the web page 234 in a new tab as the primary web page to display, and to return to the aggregator application 222 when the user indicates that the user is done using the web browser 224.

In step 302, the operating system 226 receives the request from the news aggregator application 222 to load the web page 234 externally in the web browser 224, and in step 303 the web page 234 is loaded externally in the web browser 224. Specifically, the smartphone 110 displays a graphical user interface transition from displaying the news aggregator application 222 as provided in the example illustration 410 of FIG. 4B to displaying the web browser 224 as provided in the example illustration 420 of FIG. 4C. The web browser 224, which makes available all of the web browser's standard features (e.g., from being loaded externally from the news aggregator application 222) has various features available to the user. The standard features include an input box 424 for entering a web address or search query, an options button 426, an open tabs button 428 for displaying currently open tabs in the web browser 224, and forward and backwards browsing buttons 430 and 432. The options button 426 provides options including saving the web page 234 to the user's bookmarks, reloading the web page 234, opening a new tab, opening a new private tab, viewing bookmarks, viewing tabs open on other devices associated with the user, sharing the web page 234, finding content within the web page 234, viewing a non-mobile version of the web page 234, and configuring the settings of the web browser 224.

An additional feature is also included in the web browser 224, namely, a return button 422 for returning to the news aggregator application 222. When the user has finished browsing within the web browser 224, the user presses the return button 422 to indicate the user's desire to return to the news aggregator application 222 to submit a request to end viewing of content within the web browser 224. Upon receipt of the request in the mobile web browser 224 in step 304 to end viewing of content within the web browser 224, the process 300 proceeds to step 305 in which the news aggregator application 222 is identified from among the many applications installed on the smartphone 110 in response to the request to end viewing of content within the web browser 224. Finally, in step 306, the calling application 222 is loaded, as provided in the example illustration 440 of FIG. 4D, and the process 300 ends in step 307.

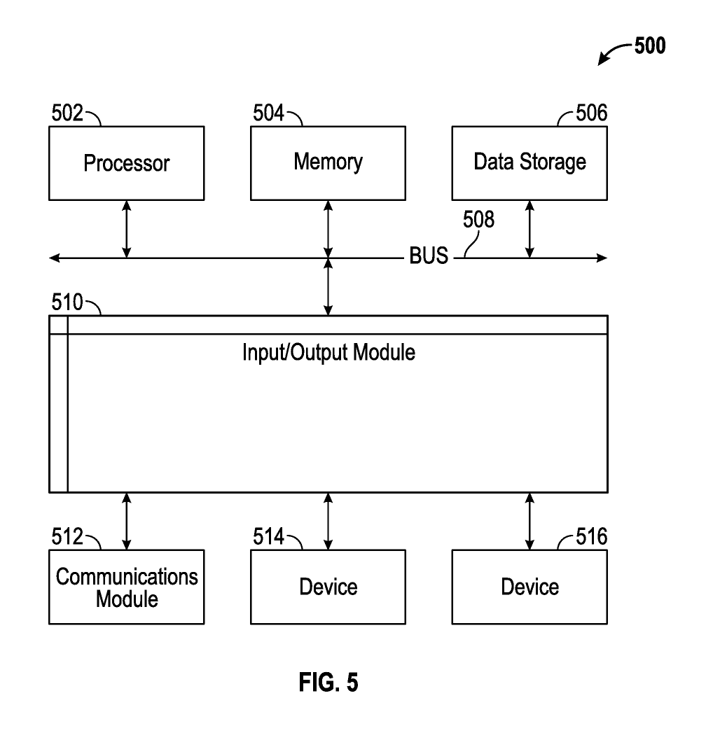

FIG. 5 is a block diagram illustrating an example computer system 500 with which the mobile client 110 and server of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., mobile client 110 and server 130) includes a bus 508 or other communication mechanism for communicating information, and a processor 502 (e.g., processor 212 and 236) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. The input/output module 510 is configured to connect to a communications module 512. Example communications modules 512 (e.g., communications module 218 and 238) include networking interface cards, such as Ethernet cards and modems. In certain aspects, the input/output module 510 is configured to connect to a plurality of devices, such as an input device 514 (e.g., input device 216) and/or an output device 516 (e.g., output device 214). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 516 include display devices, such as a LED (light emitting diode), CRT (cathode ray tube), or LCD (liquid crystal display) screen, for displaying information to the user.

According to one aspect of the present disclosure, the client 110 and server 130 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 502 for execution. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1. A computer-implemented method for switching between a web browser and an application on a mobile device, the method comprising:
receiving a request from a calling application from among a plurality of applications on a mobile device to load a web page externally in a mobile web browser on the mobile device;
loading the web page externally for display in the mobile web browser by loading the mobile web browser, on the mobile device, for display external to the calling application,
wherein the mobile web browser, which is loaded for display external to the calling application in response to the request from the calling application, is configured to provide an interface for returning to the calling application, and an interface for at least one of browsing forward and backward from the web page;
receiving a request in the mobile web browser to end viewing of content within the web browser;
identifying the calling application to load from among the plurality of applications; and
loading the calling application in response to the request to end viewing of content within the mobile web browser.

2. The method of claim 1, wherein the first application is loaded on a mobile device running an operating system, and wherein the request comprises a protocol configured for instructing the operating system to load the mobile web browser.

3. The method of claim 2, wherein the protocol comprises a Uniform Resource Identifier (URI) scheme.

4. The method of claim 3, wherein the URI scheme comprises at least one of an identification of the calling application, an action to be performed by the mobile web browser, a parameter indicating the action to be performed by the mobile web browser, a parameter specifying how to load the calling application in response to the request to end viewing of content within the web browser, a parameter indicating how to display the web page in the mobile web browser, a parameter requesting the mobile web browser to automatically add the web page as a bookmark, a parameter indicating a search query to submit to a search engine, a parameter indicating a non-mobile version of the web page is to be loaded in the mobile web browser, or a parameter indicating a request to load the web page in a private web page browsing window.

5. The method of claim 1, wherein a graphical user interface for the mobile web browser comprises at least one of an image or text identifying the calling application, and wherein selection of the at least one of the image or text comprises the request to end viewing of content within the web browser.

6. The method of claim 1, wherein loading the web page externally in the mobile web browser comprises switching from the calling application to the mobile web browser, and wherein loading the calling application comprises switching from the mobile web browser to the calling application.

7. The method of claim 1, wherein the request is received from a user, wherein the calling application is in a first state comprising a display of data entered into the calling application by the user when receiving the requesting from the calling application to load the web page externally in the mobile web browser, and wherein loading the calling application comprises loading the calling application in the first state comprising the display of data entered into the calling application by the user.

8. The method of claim 1, wherein the request is received on a mobile device, and wherein loading the web page in the mobile web browser comprises providing, for display, an interface for downloading the mobile web browser when the mobile web browser is not installed on the mobile device.

9. The method of claim 1, wherein the request is received from a user, and the method further comprising
providing, for display, an interface for the user to confirm loading the web page in the mobile web browser, and
wherein the web page is loaded in the mobile web browser in response to the user providing a confirmation to the interface.

10. The method of claim 1, wherein the mobile web browser is configured to perform at least one of conducting a web search, a selectable interface for returning to the calling application, bookmarking a web page address, sharing the web page, finding content in the web page, requesting a non-mobile version of the web page, or loading another web page in a new web page browsing window in the mobile web browser.

11. A system for switching between a web browser and an application on a mobile device, the system comprising:
a memory comprising a plurality of applications; and
a processor configured to:
receive a request from a calling application from among a plurality of applications on a mobile device to load a web page externally in a mobile web browser on the mobile device;
load the web page externally for display in the mobile web browser by the processor being configured to load the mobile web browser, on the mobile device, for display external to the calling application,
wherein the mobile web browser, which is loaded for display external to the calling application in response to the request from the calling application, is configured to provide an interface for returning to the calling application, and an interface for at least one of browsing forward and backward from the web page;
receive a request in the mobile web browser to end viewing of content within the web browser;
identify the calling application to load from among the plurality of applications; and
load the calling application in response to the request to end viewing of content within the mobile web browser,
wherein loading the web page externally in the mobile web browser comprises switching from the calling application to the mobile web browser, and wherein loading the calling application comprises switching from the mobile web browser to the calling application.

12. The system of claim 11, wherein the first application is loaded on a mobile device running an operating system; and wherein the request comprises a protocol configured for instructing the operating system to load the mobile web browser.

13. The method of claim 12, wherein the protocol comprises a Uniform Resource Identifier (URI) scheme.

14. The method of claim 13, wherein the URI scheme comprises at least one of an identification of the calling application, an action to be performed by the mobile web browser, a parameter indicating the action to be performed by the mobile web browser, a parameter specifying how to load the calling application in response to the request to end viewing of content within the web browser, a parameter indicating how to display the web page in the mobile web browser, a parameter requesting the mobile web browser to automatically add the web page as a bookmark, a parameter indicating a search query to submit to a search engine, a parameter indicating a non-mobile version of the web page is to be loaded in the mobile web browser, or a parameter indicating a request to load the web page in a private web page browsing window.

15. The system of claim 11, wherein a graphical user interface for the mobile web browser comprises at least one of an image or text identifying the calling application; and wherein selection of the at least one of the image or text comprises the request to end viewing of content within the web browser.

16. The system of claim 11, wherein the request is received from a user, wherein the calling application is in a first state comprising a display of data entered into the calling application by the user when receiving the requesting from the calling application to load the web page externally in the mobile web browser, and wherein loading the calling application comprises loading the calling application in the first state comprising the display of data entered into the calling application by the user.

17. The system of claim 11, wherein the request is received on a mobile device, and wherein loading the web page in the mobile web browser comprises providing, for display, an interface for downloading the mobile web browser when the mobile web browser is not installed on the mobile device.

18. The system of claim 11, wherein the request is received from a user, and the method further comprising
providing, for display, an interface for the user to confirm loading the web page in the mobile web browser, and
wherein the web page is loaded in the mobile web browser in response to the user providing a confirmation to the interface.

19. The system of claim 11, wherein the mobile web browser is configured to perform at least one of conducting a web search, a selectable interface for returning to the calling application, bookmarking a web page address, sharing the web page, finding content in the web page, requesting a non-mobile version of the web page, or loading another web page in a new web page browsing window in the mobile web browser.

20. A non-transitory machine-readable storage medium comprising machine-readable instructions for causing a processor to execute a method for switching between a web browser and an application on a mobile device, the method comprising:
receiving a request to load a web page externally in a mobile web browser from a calling application from among a plurality of applications on a mobile device running an operating system, the request comprising a Uniform Resource Identifier (URI) scheme configured for instructing the operating system to load the mobile web browser on the mobile device;
loading the web page externally for display in the mobile web browser by loading the mobile web browser, on the mobile device, for display external to the calling application,
wherein the mobile web browser, which is loaded for display external to the calling application in response to the request from the calling application, is configured to provide an interface for returning to the calling application, and an interface for at least one of browsing forward and backward from the web page;
receiving a request in the mobile web browser to end viewing of content within the web browser;
identifying the calling application to load from among the plurality of applications; and
loading the calling application in response to the request to end viewing of content within the mobile web browser,
wherein the URI scheme comprises at least one of an identification of the calling application, an action to be performed by the mobile web browser, a parameter indicating the action to be performed by the mobile web browser, a parameter specifying how to load the calling application in response to the request to end viewing of content within the web browser, a parameter indicating how to display the web page in the mobile web browser, a parameter requesting the mobile web browser to automatically add the web page as a bookmark, a parameter indicating a search query to submit to a search engine, a parameter indicating a non-mobile version of the web page is to be loaded in the mobile web browser, or a parameter indicating a request to load the web page in a private web page browsing window.
